(19) United States
(12) Patent Application Publication
(10) Pub. No.: US 2020/0262228 A1
(43) Pub. Date: Aug. 20, 2020

(54) INVENTION IMAGE FORMING METHOD, IMAGE FORMING APPARATUS, IMAGE FORMING SET, AND METHOD OF PRODUCING PRINTED MATTER

(71) Applicants: Hiroki HAGIWARA, Kanagawa (JP); Tomohiro NAKAGAWA, Kanagawa (JP); Kazuhiko UMEMURA, Kanagawa (JP); Yuutaroh NONAKA, Kanagawa (JP)

(72) Inventors: Hiroki HAGIWARA, Kanagawa (JP); Tomohiro NAKAGAWA, Kanagawa (JP); Kazuhiko UMEMURA, Kanagawa (JP); Yuutaroh NONAKA, Kanagawa (JP)

(21) Appl. No.: 16/794,317

(22) Filed: Feb. 19, 2020

(30) Foreign Application Priority Data
Feb. 19, 2019 (JP) 2019-027151

(51) Int. Cl. B41M 5/00; C09D 11/40; C09D 11/322; C09D 11/36

(52) U.S. Cl. CPC B41M 5/0023; B41M 5/0047; C09D 11/36; C09D 11/322; C09D 11/40

(57) ABSTRACT

An image forming method includes applying a pre-processing fluid to a non-absorptive recording medium, the pre-processing fluid containing a multi-valent metal salt and at least one organic solvent and applying a magenta ink containing C.I. Pigment Red 269 and at least one organic solvent, wherein the mixing SP value of the at least one organic solvent contained in the pre-processing fluid is from 10.0 to 12.0 (cal/cm³), wherein the mixing SP value of the at least one organic solvent contained in the magenta ink is from 12.0 to 14.0 (cal/cm³).

### CROSS-REFERENCE TO RELATED APPLICATIONS

This patent application is based on and claims priority pursuant to 35 U.S.C. § 119 to Japanese Patent Application No. 2019-027151, filed on Feb. 19, 2019 in the Japan Patent Office, the entire disclosure of which is hereby incorporated by reference herein.

### BACKGROUND

### Technical Field

The present invention relates to an image forming method, an image forming apparatus, an image forming set, and a method of producing printed matter.

### Description of the Related Art

Technologies of printing images have been used for home use but now developed for packaging materials for food, beverages, commodities, etc. utilizing an inkjet method have also been developed. In Japan, non-absorptive recording media such as plastic films have been used and inks therefor have been developed.

Direct inkjet printing on package for food and articles for daily use is an example of a needs of direct printing on such a non-absorptive recording medium. Since such printed matter is viewed in a close range in many occasions, it requires extremely high image quality.

Meanwhile, the current mainstream in the package printing is analog printing such as offset printing and flexography printing. However, as small-lot wide-variety production of package designs becomes popular, there have been increasing needs for inkjet printers that obviates the need for plates as digital printing.

### SUMMARY

According to embodiments of the present disclosure, provided is an image forming method which includes applying a pre-processing fluid to a non-absorptive recording medium, the pre-processing fluid containing a multi-valent metal salt and at least one organic solvent and applying a magenta ink containing C.I. Pigment Red 269 and at least one organic solvent, wherein the mixing SP value of the at least one organic solvent contained in the pre-processing fluid is from 10.0 to 12.0 (cal/cm³), wherein the mixing SP value of the at least one organic solvent contained in the magenta ink is from 12.0 to 14.0 (cal/cm³).

### BRIEF DESCRIPTION OF THE SEVERAL VIEWS OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a diagram illustrating perspective view of an example of the image forming apparatus according to an embodiment of the present disclosure;

FIG. 2 is a diagram illustrating a perspective view of an example of the tank of the image forming apparatus according to an embodiment of the present disclosure;

FIG. 3 is a schematic diagram illustrating another example of the image forming apparatus according to another embodiment of the present disclosure; and

FIG. 4 is a schematic diagram illustrating a pre-processing fluid application device of the pre-processing unit illustrated in FIG. 3.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

Moreover, image forming, recording, printing, modeling, etc., in the present disclosure represent the same meaning, unless otherwise specified.

Embodiments of the present invention are described in detail below with reference to accompanying drawing(s). In describing embodiments illustrated in the drawing(s), specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

As for ink, printers loaded with solvent inks or UV-curable inks are commercially available. Meanwhile, there has been an increasing demand for aqueous ink in terms of safety of the workers and the environment. However, the aqueous ink has a high surface tension, causing a problem with spreading on a non-absorptive recording medium, which may result in dot omission in an image.

For this reason, for example, an aqueous inkjet ink has been proposed in JP-6376505-B1 (JP-2018-115325-A1) which contains a water-soluble organic solvent having a Specific physical property value and a surfactant, thereby preventing density unevenness and dot omission over sparingly absorptive substrate and obtaining excellent discharging stability and an excellent drying property.

Image Forming Method and Image Forming Apparatus

The image forming method of the present disclosure includes applying a pre-processing fluid to a non-absorptive recording medium, the pre-processing fluid containing a multi-valent metal salt and at least one organic solvent and applying a magenta ink containing C.I. Pigment Red 269 and at least one organic solvent, wherein the mixing SP value of the at least one organic solvent contained in the pre-processing fluid is from 10.0 to 12.0 (cal/cm³), wherein the mixing SP value of the at least one organic solvent contained in the magenta ink is from 12.0 to 14.0 (cal/cm³). It also includes other optional steps.

The image forming apparatus of the present disclosure includes a pre-processing fluid applying unit configured to apply a pre-processing fluid to a non-absorptive recording medium, the pre-processing fluid containing a multi-valent metal salt and at least one organic solvent, and an ink applying unit configured to apply a magenta ink containing C.I. Pigment Red 269 and at least one organic solvent, wherein the mixed SP value of the at least one organic solvent contained in the pre-processing fluid is from 10.0 to 12.0 (cal/cm³), wherein the mixed SP value of the at least one organic solvent contained in the magenta ink is from 12.0 to 14.0 (cal/cm³). It also includes other optional device.

The ink proposed in JP-6376505-B1 (JP-2018-115325-A1) mentioned above is proven to be excellent over recording media such as coat paper. However, since a pre-processing fluid is not applied, wettability of the ink is not sufficient for a non-absorptive recording medium that has a higher surface energy and is not easily wet, which may cause density unevenness.

The image forming method of the present disclosure includes applying a pre-processing fluid to a non-absorptive recording medium, the pre-processing fluid containing a multi-valent metal salt and at least one organic solvent and applying a magenta ink containing C.I. Pigment Red 269 and at least one organic solvent, wherein the mixing SP value of the at least one organic solvent contained in the pre-processing fluid is from 10.0 to 12.0 (cal/cm³), wherein the mixing SP value of the at least one organic solvent contained in the magenta ink is from 12.0 to 14.0 (cal/cm³). The image forming method enables a uniform wettability/spreadability over any kinds of non-absorptive recording media, enables even an ink attached in a low amount to exhibit a good image filling efficiency, provides an excellent drying property and an excellent image density, and provides an excellent ink discharging stability by reducing aggregation of the ink in nozzles.

Pre-Processing Fluid Applying Process and Pre-Processing Fluid Applying Device

The pre-processing fluid applying process is to apply the pre-processing fluid to a recording medium executed by the pre-processing fluid applying device.

Pre-Processing Fluid

The pre-processing fluid contains a multi-valent metal salt and at least one organic solvent. It preferably contains water and other optional components.

Organic Solvent

A mixing SP value of the at least one organic solvent contained in the pre-processing fluid is from 10.0 to 12.0 (cal/cm³)^{1/2}. It is preferable that the mixing SP value of the at least one organic solvent contained in the pre-processing fluid be from 10.0 to 12.0 (cal/cm³)^{1/2}, a uniform wettability/spreadability is demonstrated over any types of non-absorptive recording media and density unevenness is reduced even with a small amount of ink attached thereto. The mechanism is that when the mixing SP value of the at least one organic solvent contained in the pre-processing fluid is 12.0 (cal/cm³)^{1/2} or less, the ink can uniformly wet and spread even over non-absorptive recording media having a high surface energy. Further, when the mixing SP value of the at least one organic solvent contained in the pre-processing fluid is 10.0 (cal/cm³)′¹² or greater, even an aqueous ink having a high surface tension can uniformly wet and spread when discharged over the pre-processing fluid.

The solubility parameter (SP) value of the at least one organic solvent contained in the pre-processing fluid is preferably from 9.0 to 12.0 (cal/cm³)^{1/2} and more preferably from 9.0 to 10.5 (cal/cm³)^{1/2}. By containing organic solvents having such a low SP value in a high proportion, the pre-processing fluid has a higher wettability over a non-absorbable print medium and uniformly wets and spreads. Hence, the magenta ink to be discharged onto the pre-processing fluid also wets and spreads uniformly.

The SP value means a solubility parameter and is used in general as an indicator for affinity and solubility of materials such as a solvent, a resin, and a pigment dissolved or dispersed in water or a solvent for use.

The SP value can be obtained by various ways such as measuring by experiments, calculating by measuring physical property such as immersion heat, or calculating from molecular structures. In the present disclosure, the SP value is obtained by the calculation method based on the molecule structure proposed by Fedors.

This method has advantages that the SP value can be calculated if a molecule structure is known and the difference between the SP value obtained from this method and the measuring value based on experiments is small.

The Fedors method can obtain SP values according to a formula A based on the evaporation energy Δei and the molar volume Δvi of each atom or a group of atoms at 25 degrees C.

SP value=(ΣΔei/Δvi)^{1/2} formula (A)

In the present disclosure, according to the Method of Fedors, the SP value calculated from the molecular structure is used and represented in (cal/cm³)^{1/2}.

Also, in the present disclosure, the SP value at 25 degrees C. is used and not subject to temperature conversion, etc.

SP values can be calculated according to the Fedors method described in the following document: R. F. Fedors: Polym. Eng. Sci., 14[2], 147-154

Definition of Mixing SP Value

A mixing SP value of a liquid mixture of the organic solvents contained in the pre-processing fluid can be calculated according to the following relationship 1 based on the molar fractions of the organic solvents contained in the pre-processing fluid. Only the organic solvents not containing water and having a proportion of 2 percent by mass or greater to the total amount of the pre-processing fluid are counted in the calculation of the mixing SP value.

Mixing SP value (cal/cm³)^{0.5} of the liquid mixture of the organic solvents in the pre-processing fluid=[SP value of organic solvent A×molar fraction of organic solvent A]+[SP value of organic solvent B×molar fraction of organic solvent B]+ . . . Relationship 1

Specific examples of the organic solvent include, but are not limited to, 2-methoxyethanol (with an SP value of 10.7 (cal/cm³)^{1/2}), 2-ethoxyethanol (with an SP value of =10.4 (cal/cm³)^{1/2}), 3-methoxybutanol (with an SP value of 10.9 (cal/cm³)^{1/2}), 1-methoxy-2-propanol (propylene glycol-1-monomethylether) (with an SP value of 10.2 (cal/cm³)^{1/2}), 2-methoxy-1-propanol (propylene glycol-2-methylether) (with an SP value of 10.2 (cal/cm³)^{1/2}, ethylene glycol monobutylether (with an SP value of 10.0 (cal/cm³)^{1/2}), 3-methoxy-3-methyl-1-butanol (with an SP value of 9.6 (cal/cm³)^{1/2}), 2,2′-oxybis-1-propanol (with an SP value of 11.7, (cal/cm³)^{1/2}), propylene glycol n-propylether (with an SP value of 9.8 (cal/cm³)^{1/2}), propylene glycol n-butylether (with an SP value of 9.7 (cal/cm³)^{1/2}), dipropylene glycol methylether (with an SP value of 9.7 (cal/cm³)^{1/2}), diethylene glycol monoethylether (with an SP value of 10.9 (cal/cm³)^{1/2}), dipropylene glycol n-propylether (with an SP value of 9.5 (cal/cm³)^{1/2}), dipropylene glycol n-butylether (with an SP value of 9.4 (cal/cm³)^{1/2}), tripropylene glycol methylether (with an SP value of 9.4 (cal/ccm³)^{1/2}), and tripropylene glycol n-butylether (with an SP value of 9.3 (cal/ccm³)^{1/2}).

These can be used alone or in combination.

Of these organic solvents, glycol ether compounds are preferable and propylene glycol alkylether is more preferable in terms of wettability/spreadability over non-absorptive recording media.

Other optional organic solvents can be used in combination in addition to the organic solvents mentioned above.

There is no specific limitation to the other optional organic solvent. For example, water-soluble organic solvents can be used. Examples include, but are not limited to, polyhydric alcohols, ethers such as polyhydric alcohol alkylethers and polyhydric alcohol arylethers, nitrogen-containing heterocyclic compounds, amides, amines, and sulfur-containing compounds.

Specific examples of the water-soluble organic solvents include, but are not limited to, polyols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, and petriol; polyol alkylethers such as ethylene glycol monoethylether, ethylene glycol monobutyl ether, diethylene glycol monomethylether, diethylene glycol monoethylether, diethylene glycol monobutyl ether, tetraethylene glycol monomethylether, and propylene glycol monoethylether; polyol arylethers such as ethylene glycol monophenylether and ethylene glycol monobenzylether; nitrogen-containing heterocyclic compounds such as 2-pyrrolidone, N-methyl-2-pyrrolidone, N-hydroxyethyl-2-pyrrolidone, 1,3-dimethyl-2-imidazolidinone, E-caprolactam, and γ-butyrolactone; amides such as formamide, N-methylformamide, N,N-dimethylformamide, 3-methoxy-N,N-dimethyl propioneamide, and 3-buthoxy-N,N-dimethyl propioneamide; amines such as monoethanolamine, diethanolamine, and triethylamine; sulfur-containing compounds such as dimethyl sulfoxide, sulfolane, and thiodiethanol; propylene carbonate, and ethylene carbonate.

To serve as a humectant and impart a good drying property, it is preferable to use an organic solvent having a boiling point of 250 degrees C. or lower.

The proportion of the organic solvent in the total amount of the pre-processing fluid is not particularly limited and can be suitably selected to suit to a particular application. For example, it is preferably from 10 to 60 percent by mass and more preferably from 20 to 60 percent by mass in terms of drying property.

Multi-Valent Metal Salt

The multi-valent metal salt destabilizes dispersion of a coloring material in the ink and can aggregate the pigment in the ink quickly after the ink droplets land on the pre-processing fluid, thereby reducing occurrence of color bleed and enhancing coloring.

Cations of the multi-valent metal salt are not particularly limited and can be suitably selected to suit to a particular application.

Specific examples of the cations of the multi-valent metal salt include, but are not limited to, ions of aluminum (Al (III)), calcium (Ca (II)), magnesium (Mg (II)), copper (Cu (II)), iron (Fe (II) or Fe (III)), zinc (Zn (II)), tin (Sn (II) or Sn (IV)), strontium (Sr (II)), nickel (Ni (II)), cobalt (Co (II)), barium (Ba (II)), lead (Pb (II)), zirconium (Zr (IV)), titanium (Ti (IV)), antimony (Sb (III)), bismuth (Bi (III)), tantalum (Ta (V)), arsenic (As (III)), cerium (Ce (III)), lanthanum (La (III)), yttrium (Y (III)), mercury (Hg (II)), and beryllium (Be (II)). These can be used alone or in combination. Of these, calcium (Ca (II)) and magnesium (Mg (II)) are preferable.

Anions of the multi-valent metal salt are not particularly limited and can be suitably selected to suit to a particular application.

Specific examples include, but are not limited to, ions of halogen elements such as fluorine (F), chlorine (Cl), bromine (Br), and iodine (I); nitrate ions (NO³⁻) and sulfate ions (SO₄²⁻); ions of organic carboxylic acids such as formic acid, acetic acid, lactic acid, malonic acid, oxalic acid, maleic acid, and benzoic acid; ions of organic sulfonic acids such as benzene sulfonic acid, naphthol sulfonic acid, and alkylbenzene sulfonic acid; and thiocyanic ions (SCN—, thiosulfate ions S₂O₃²⁻), phosphate ions (PO₄³⁻), and nitrite ions (NO²⁻). These can be used alone or in combination. Of these anions, chlorine ions (Cl⁻), sulfate ions (SO₄²⁻), acetate ions, and nitrate ions (NO₃⁻) are preferable in terms of cost and safety.

The multi-valent metal salt is not particularly limited and can be suitably selected to suit to a particular application. Specific examples include, but are not limited to, aluminum chloride, calcium chloride, nickel chloride, potassium acetate, sodium acetate, calcium acetate, magnesium acetate, aluminum nitrate, magnesium nitrate, magnesium chloride, calcium nitrate, magnesium hydroxide, aluminum sulfate, magnesium sulfate, and ammonium alum. More specific examples include, but are not limited to, calcium acetate monohydrate, calcium nitrate tetrahydrate, calcium chloride hexahydrate, magnesium acetate tetrahydrate, magnesium sulfate (anhydrous), aluminum nitrate nonahydrate, and nickel chloride hexahydrate. These can be used alone or in combination. Of these, calcium acetate monohydrate, calcium nitrate tetrahydrate, calcium chloride hexahydrate, magnesium acetate tetrahydrate, and magnesium sulfate (anhydrous) are preferable.

The proportion of the multi-valent metal salt to the total amount of the pre-processing fluid is preferably from 0.1 to 5 percent by mass and more preferably from 0.5 to 3 percent by mass.

Water

There is no specific limitation to the water and it can be suitably selected to suit to a particular application. For example, pure water such as deionized water, ultrafiltered water, reverse osmosis water, and distilled water and ultra pure water are suitable. These can be used alone or in combination.

Other Optional Component

Examples of the other optional components are organic solvents, surfactants, defoaming agents, preservatives and fungicides, and corrosion inhibitors

Surfactant

Examples of the surfactant include, but are not limited to, silicone-based surfactants, fluorochemical surfactants, amphoteric surfactants, nonionic surfactants, and anionic surfactants.

The silicone-based surfactant has no specific limit and can be suitably selected to suit to a particular application. Of these, surfactants not soluble in a high pH environment are preferable. Examples of the silicone-based surfactants include, but are not limited to, side-chain-modified polydimethyl siloxane, both distal-end-modified polydimethyl siloxane, one-distal-end-modified polydimethyl siloxane, and side-chain-both-distal-end-modified polydimethyl siloxane. In particular, silicone-based surfactants having a polyoxyethylene group or a polyoxyethylene polyoxypropylene group as a modification group are particularly preferable because such an aqueous surfactant demonstrates good property. It is possible to use a polyether-modified silicone-based surfactant as the silicone-based surfactant. A specific example thereof is a compound in which a polyalkylene oxide structure is introduced into the side chain of the Si site of dimethyl siloxane.

Specific examples of the fluorochemical surfactant include, but are not limited to, perfluoroalkyl sulfonic acid compounds, perfluoroalkyl carboxylic acid compounds, ester compounds of perfluoroalkyl phosphoric acid, adducts of perfluoroalkyl ethylene oxide, and polyoxyalkylene ether polymer compounds having a perfluoroalkyl ether group in its side chain. These are particularly preferable because the fluorochemical surfactant does not easily produce foams.

Specific examples of the perfluoroalkyl sulfonic acid compounds include, but are not limited to, perfluoroalkyl sulfonic acid and salts of perfluoroalkyl sulfonic acid. Specific examples of the perfluoroalkyl carbonic acid compounds include, but are not limited to, perfluoroalkyl carbonic acid and salts of perfluoroalkyl carbonic acid.

Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain, and salts of polyoxyalkylene ether polymers having a perfluoroalkyl ether group in its side chain. Counter ions of salts in these fluoro-surfactants are, for example, Li, Na, K, NH₄, NH₃CH₂CH₂OH, NH₂(CH₂CH₂OH)₂, and NH(CH₂CH₂OH)₃.

Specific examples of the ampholytic surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides.

Specific examples of the anionic surfactants include, but are not limited to, polyoxyethylene alkylether acetates, dodecyl benzene sulfonates, laurates, and polyoxyethylene alkylether sulfates.

These can be used alone or in combination.

The proportion of the surfactant is not particularly limited and can be suitably selected to suit to a particular application. For example, it is preferably from 0.001 to 5 percent by mass and more preferably from 0.05 to 5 percent by mass in terms of enhancement of image quality.

Defoaming Agent

The defoaming agent is not particularly limited and can be suitably selected to suit to a particular application. For example, silicon-based defoaming agents, polyether-based defoaming agents, and aliphatic acid ester-based defoaming agents are suitable. These can be used alone or in combination. Of these, silicone-based defoaming agents are preferable in terms of the effect of foam breaking.

Preservatives and Fungicides

The preservatives and fungicides are not particularly limited and can be suitably selected to suit to a particular application. A specific example is 1,2-benzisothiazoline-3-one.

Corrosion Inhibitor

The corrosion inhibitor has no particular limit and can be suitably selected to suit to a particular application. Specific examples include, but are not limited to, acid sulfite and sodium thiosulfate.

There is no specific limit to the method of applying the pre-processing fluid and it can be suitably selected to suit to a particular application.

Specific examples include, but are not limited, an inkjet method, a blade coating method, a gravure coating method, a gravure offset coating method, a bar coating method, a roll coating method, a knife coating method, an air knife coating method, a comma coating method, a U comma coating method, an AKKU coating method, a smoothing coating method, a microgravure coating method, a reverse roll coating method, a four or five roll coating method, a dip coating method, a curtain coating method, a slide coating method, and a die coating method. The application method can be appropriately selected according to the material, thickness, etc. of the non-permeable recording medium.

The application amount of the pre-processing fluid has no particular limit and can be suitably selected to suit to a particular application. For example, the specific application amount is preferably from 0.5 to 6.3 g/m², more preferably from 1 to 6 g/m², and furthermore preferably from 2 to 4 g/m². When the application amount of the pre-processing fluid is from 0.5 g/m² to 6.3 g/m², the aggregation ability of the multi-valent metal salt of the pre-processing fluid and the ink pigment and the diminishing ability of the ink flowing from a solid image by the resin particle in the pre-processing fluid strike a balance, which makes it possible to form a high quality image.

Recording Medium

Non-absorptive recording media are suitable as the recording media for use in the present disclosure.

The non-absorptive recording medium in the present disclosure has a surface with low moisture permeability, absorbency, and/or adsorptivity and contains a material having myriad of hollow spaces inside but not open to the exterior.

To be more quantitative, the non-permeable recording medium has a water-absorption amount of 10 mL/m² or less between the initiation of contact and 30 msec^{1/2}, thereafter according to Bristow method.

Of the non-absorptive recording media, polypropylene films, polyethylene terephthalate films, and nylon films are preferable because inks can wet and spread uniformly over these films.

Specific examples of the polypropylene film include, but are not limited to, P-2102, P-2002, P-2161, P-4166, all manufactured by TOYOBO CO., LTD., PA-20, PA-30, and PA-20W, all manufactured by SunTox Co., Ltd., and FOA, FOS, and FOR, all manufactured by FUTAMURA CHEMICAL CO., LTD.

Specific examples of the polyethylene terephthalate film include, but are not limited to, E-5100 and E-5102, both manufactured by TOYOBO CO., LTD., P60 and P375, both manufactured by Toray Industries, Inc., and G2, G2P2, K, and SL, all manufactured by Teijin Dupont Film Japan Limited.

Specific examples of the nylon film include, but are not limited to, HARDEN film N-1100, N-1102, and N-1200, all manufactured by TOYOBO CO., LTD., and ON, NX, MS, and NK, all manufactured by UNITIKA LTD.

Ink Applying Process and Ink Applying Device

In the ink applying process, a magenta ink containing C.I. Pigment Red 269 and organic solvents is applied, which is executed by the ink applying unit.

Magenta Ink

The magenta ink contains C.I. Pigment Red 269, organic solvents, and other optional components.

C.I. Pigment Red 269

C.I. Pigment Red 269 is represented by the following Chemical formula.

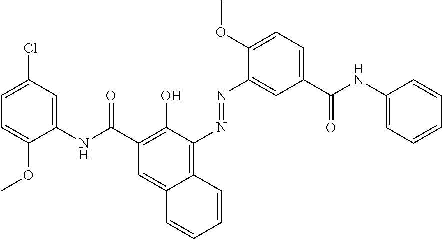 [SMILES: COc1ccc(C(=O)Nc2ccccc2)cc1/N=N/c1c(O)c(C(=O)Nc2cc(Cl)ccc2OC)cc2ccccc12]

Inclusion of C.I. Pigment Red 269 in the magenta ink, which is an azo pigment having a high color developability and an excellent color reproducibility contributes to sufficient demonstration even with a small amount of ink. Moreover, since image quality can be ensured by a small amount of ink attached, a good drying property is demonstrated during high performance printing even for a short drying time.

The proportion of C.I. Pigment Red 269 in the magenta ink is preferably from 0.1 to 10 percent by mass and more preferably from 1 to 6 percent by mass in terms of enhancing image density and discharging stability.

Organic Solvent

The mixing SP value of the organic solvents contained in the magenta ink is from 12.0 to 14.0 (cal/cm³)^{1/2}.

When the mixing SP value of the organic solvents is 14.0 (cal/cm³)^{1/2} or less, it is close to the SP value of the pre-processing fluid of from 10.0 to 12.0 (cal/cm³)^{1/2}. This enables the ink to uniformly wet and spread on the pre-processing fluid even with a small amount of the ink. Conversely, when the mixing SP value of the organic solvents contained in the magenta ink is 12.0 (cal/cm³)^{1/2} or greater, it is possible to prevent defective discharging ascribable to thickening of the ink caused by aggregation of the pigment since a pigment dispersion is stopped from being attacked by a hydrophobic solvent in a nozzle. Hence, a good dischargeability can be obtained.

The solubility parameter (SP) value of the organic solvents contained in the magenta ink is preferably from 9.0 to 12.0 (cal/cm³)^{1/2} and more preferably from 9.0 to 10.5 (cal/cm³)^{1/2}. Inclusion of the organic solvents having SP values of from 9.0 to 10.5 (cal/cm³)^{1/2} in the magenta ink makes it possible to prevent defective discharging ascribable to aggregation of pigments in a nozzle while enhancing wettability of the magenta ink on a non-absorptive recording medium to which the pre-processing fluid is applied.

As the organic solvents in the magenta ink, the same organic solvents contained in the pre-processing fluid can be used. Appropriate organic solvents can be selected from such organic solvents and adjusted in such a manner that the mixing SP value of the organic solvents in the magenta ink is from 12.0 to 14.0 (cal/cm³)^{1/2}.

As the organic solvents contained in the magenta ink, glycol ether compounds are preferable and propylene glycol alkylether is more preferable.

Glycol ether compounds are preferable as the organic solvents because the magenta ink uniformly wets and spreads over a non-absorptive recording medium.

Water

The proportion of water in the magenta ink is not particularly limited and can be suitably selected to suit to a particular application. In terms of drying property and discharging stability of the magenta ink, the proportion is preferably from 10 to 90 percent by mass and more preferably from 20 to 60 percent by mass.

The water mentioned above has no particular limit and can be suitably selected to suit to a particular application.

For example, the same water as that in the pre-processing fluid can be used.

Resin

The type of the resin contained in the magenta ink has no particular limit and can be suitably selected to suit to a particular application. Examples include, but are not limited to, urethane resins, polyester resins, acrylic-based resins, vinyl acetate-based resins, styrene-based resins, butadiene-based resins, styrene-butadiene-based resins, vinylchloride-based resins, acrylic styrene-based resins, and acrylic silicone-based resins.

Resin particles formed of these resins may be also used. It is possible to mix a resin emulsion in which such resin particles are dispersed in water as a dispersion medium with materials such as a coloring material and an organic solvent to obtain an ink. It is possible to use suitably-synthesized resin particles as the resin particle. Alternatively, the resin particle available on the market can be used. These resin particulates can be used alone or in combination.

The mean volume diameter (volume average particle diameter) of the resin particle is not particularly limited and can be suitably selected to suit to a particular application. The mean volume diameter is preferably from 10 to 1,000 nm, more preferably from 10 to 200 nm, and particularly preferably from 10 to 100 nm to obtain good fixability and image robustness.

The volume average particle diameter can be measured by using, for example, a particle size analyzer (Nanotrac Wave-UT151, manufactured by MicrotracBEL Corp.).

The proportion of the resin in the ink is not particularly limited and can be suitably selected to suit to a particular application. In terms of fixability and storage stability of the ink, it is preferably from 1 to 30 percent by mass and more preferably from 5 to 20 percent by mass to the total amount of the ink.

The particle diameter of the solid portion in the magenta ink is not particularly limited and can be suitably selected to suit to a particular application. For example, the maximum frequency in the maximum number conversion is preferably 20 to 1,000 nm and more preferably 20 to 150 nm to ameliorate the discharging stability and image quality such as image density. The solid portion includes resin particulate, pigment particulate, etc. The particle diameter can be measured by using a particle size analyzer (Nanotrac Wave-UT151, manufactured by MicrotracBEL Corp).

Other Components

Examples of the other component are surfactants, defoaming agents, preservatives and fungicides, corrosion inhibitors, and pH regulators.

Surfactant

The surfactant has no particular limit and can be suitably selected to suit to a particular application.

For example, the same surfactant as that in the pre-processing fluid can be used.

Defoaming Agent

The defoaming agent has no particular limit and can be suitably selected to suit to a particular application.

For example, the same defoaming agent as that in the pre-processing fluid can be used.

Preservatives and Fungicides

The preservatives and fungicides have no particular limit and can be suitably selected to suit to a particular application.

For example, the same preservatives and fungicides as those in the pre-processing fluid can be used.

Corrosion Inhibitor

The corrosion inhibitor has no particular limit and can be selected to suit to a particular application.

For example, the same corrosion inhibitor as that in the pre-processing fluid can be used.

pH Regulator

The pH regulator has no particular limit as long as it can control pH to be not lower than 7.

Specific examples include, but are not limited to, amines such as diethanol amine and triethanol amine.

The magenta ink can be prepared by dispersing or dissolving these components in, for example, water as a solvent, optionally followed by stirring and mixing.

A stirrer using a typical stirring blade, a magnetic stirrer, a high performance disperser etc., can be used for the mixing and stirring.

Properties of the magenta ink are not particularly limited and can be suitably selected to suit to a particular application. For example, viscosity, surface tension, and pH are preferably in the following ranges.

Viscosity of the ink at 25 degrees C. is preferably from 5 to 30 mPa·s and more preferably from 5 to 25 mPa·s to improve print density and text quality and obtain good dischargeability. Viscosity can be measured by, for example, a rotatory viscometer (RE-80L, manufactured by TOKI SANGYO CO., LTD.). The measuring conditions are as follows:
Standard cone rotor (1°34′×R24)
Sample liquid amount: 1.2 mL
Rotational frequency: 50 rotations per minute (rpm)
25 degrees C.
Measuring time: three minutes.

The surface tension of the ink is preferably 35 mN/m or less and more preferably 32 mN/m or less at 25 degrees C. in terms that the ink is suitably leveled on a recording medium and the drying time of the ink is shortened.

pH of the ink is preferably from 7 to 12 and more preferably from 8 to 11 in terms of prevention of corrosion of metal material in contact with liquid.

The magenta ink is applied by an inkjet method.

To form quality images having an excellent solid image filling property while reducing color bleed, the application amount of the ink when forming a solid image is preferably from 4 to 14 g/m², more preferably from 7 to 14 g/m².

When printed with small droplet ink, it is preferable to reduce the application amount of the ink.

Other Processes and Other Devices

The other processes include a drying process, a control process, etc.

The other devices include a drying device, a control device, etc.

Recording Device and Recording Method

The magenta ink for use in the present disclosure can be suitably applied to various recording devices employing an inkjet recording method, such as printers, facsimile machines, photocopiers, multifunction peripherals (serving as a printer, a facsimile machine, and a photocopier), and solid freeform fabrication devices (3D printers, additive manufacturing devices).

In the present disclosure, the recording device and the recording method respectively represent a device capable of discharging ink, various processing liquids, etc., to a recording medium and a method of recording utilizing the device. The recording medium means an article to which ink or various processing fluids can be temporarily or permanently attached.

The recording device may further optionally include a device relating to feeding, conveying, and ejecting a recording medium and other devices referred to as a pre-processing device, a post-processing device, etc., in addition to the head portion to discharge the ink.

The recording device and the recording method may further optionally include a heating device (heater) for use in the heating process and a drying device (drier) for use in the drying process. For example, the heating device and the drying device heat and dry the print surface and the opposite surface of a recording medium. The heating device and the drying device are not particularly limited. For example, a fan heater and an infra-red heater can be used. Heating and drying can be conducted before, in the middle of, or after printing.

In addition, the recording device and the recording method are not limited to those producing meaningful visible images such as texts and figures with ink. For example, the recording method and the recording device capable of producing patterns like geometric design and 3D images are included.

In addition, the recording device includes both a serial type device in which the discharging head is allowed to move and a line type device in which the liquid discharging head is not moved, unless otherwise specified.

Furthermore, in addition to the desktop type, this recording device includes a device capable of printing images on a wide recording medium such as AO and a continuous printer capable of using continuous paper rolled up in a roll form as a recording medium.

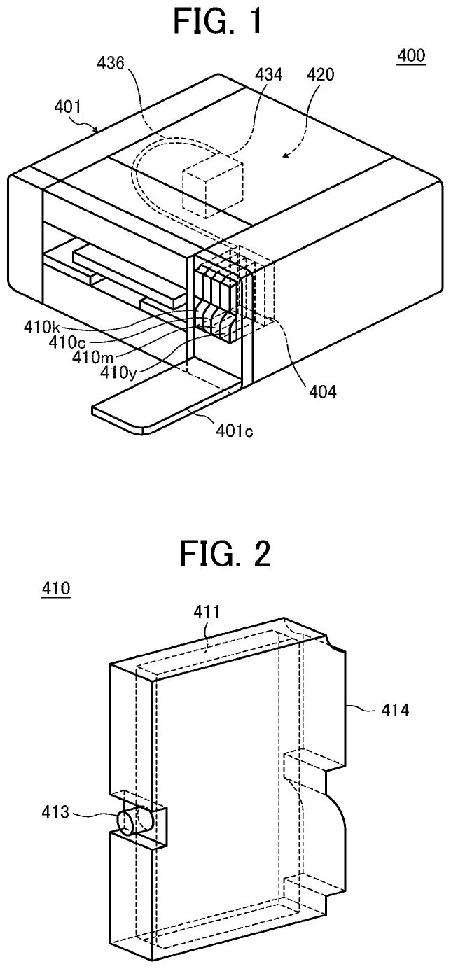

The recording device is described using an example with reference to FIG. 1 and FIG. 2. FIG. 1 is a diagram illustrating a perspective view of the recording device. FIG. 2 is a diagram illustrating a perspective view of the tank. An image forming device 400 as an embodiment of the recording device is a serial type image forming device. A mechanical unit 420 is disposed in an exterior 401 of the image forming apparatus 400. Each ink accommodating unit (ink container) 411 of each tank 410 (410k, 410c, 410m, and 410y) for each color of black (K), cyan (C), magenta (M), and yellow (Y) is made of, for example, packaging material such as aluminum laminate film. The ink accommodating unit 411 is housed in, for example, a plastic container housing unit 414. Due to this configuration, the tank 410 is used as an ink cartridge for each color.

A cartridge holder 404 is disposed on the rear side of the opening appearing when a cover 401c is opened. The tank 410 is detachably attached to the cartridge holder 404. This enables each ink outlet 413 of the tank 410 to communicate with a discharging head 434 for each color via a supplying tube 436 for each color so as to discharge the ink from the discharging head 434 to a recording medium.

This recording device may include not only a portion to discharge ink but also a device referred to as a pre-processing device, a post-processing device, etc.

As an example of the pre-processing device and the post-processing device, like the ink of black (K), cyan (C), magenta (M), and yellow (Y) ink, the pre-processing device and the post-processing device may further include a liquid accommodating unit including a pre-processing liquid or a post-processing liquid and a liquid discharging head to discharge the pre-processing liquid or the post-processing liquid according to an inkjet printing method.

As another example of the pre-processing device and the post-processing device, it is suitable to dispose a pre-processing device and a post-processing device not employing the inkjet printing method but a blade coating method, a roll coating method, or a spray coating method.

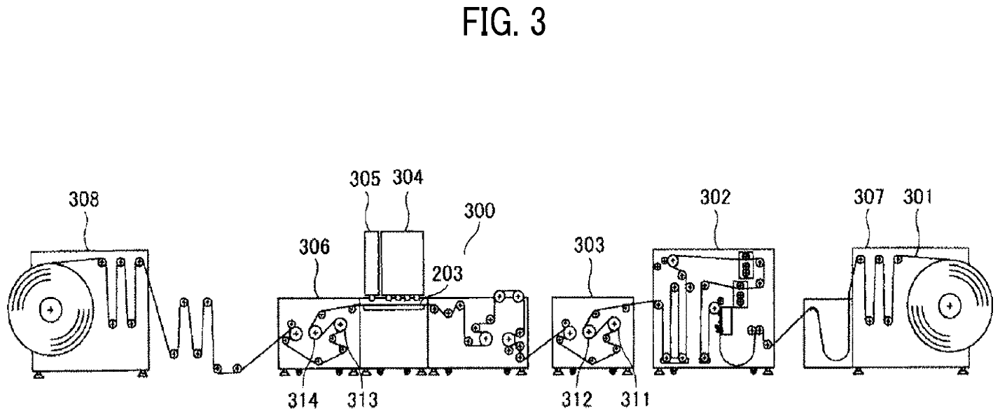

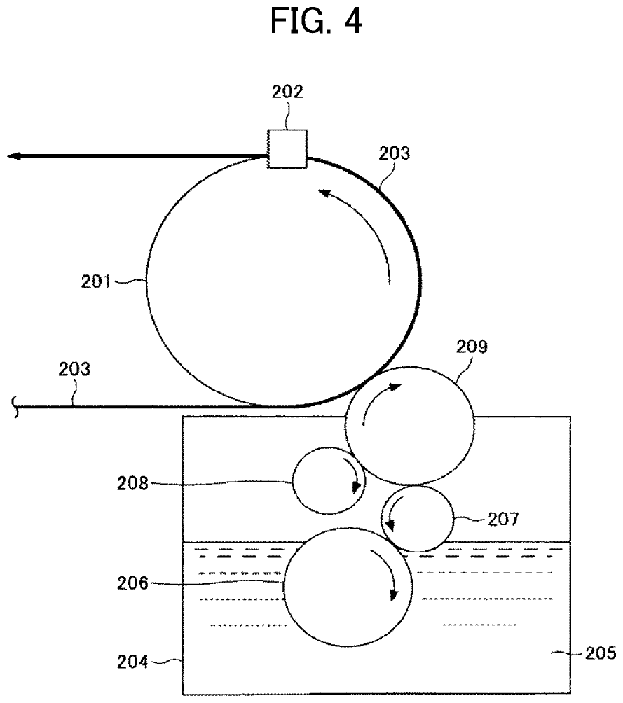

Next, the image forming device including the pre-processing fluid application device illustrated in FIG. 3 and the pre-processing fluid application device of the pre-processing unit illustrated in FIG. 4 are described.

An image forming apparatus 300 illustrated in FIG. 3 includes a recording medium conveyance unit 301, a pre-processing unit 302 to apply a pre-processing fluid to a recording medium 203, a drying unit 303 to dry the recording medium 203 to which the pre-processing fluid is already applied, an inkjet recording unit 304 to form an image on the dried recording medium 203 by discharging an aqueous pigment ink thereto, a post-processing unit 305 to apply a post-processing fluid to the recording medium 203 after the image is formed thereon, and a second drying unit 306 to dry the recording medium 203 to which the post-processing fluid is already applied.

The recording medium conveyance unit 301 has a sheet feeder 307, multiple conveyor rollers, and a reeling unit 308. The recording medium 203, which is continuous roll paper, is reeled out from the sheet feeder 307 by the conveyance rollers, and thereafter reeled up by the reeling unit 308.

The recording medium 203 conveyed from the recording medium conveyance unit 301 is coated with the pre-processing fluid by the pre-processing fluid application unit 204 (illustrated in FIG. 2) of the pre-processing unit 302.

As illustrated in FIG. 4, a pre-processing fluid 205 is accommodated inside the pre-processing fluid application unit 204. In this unit, a thin film of the pre-processing fluid 205 is formed on the surface of an application roller 209 by a stirring and supplying roller 206, a conveyance roller 207, and a thin film forming roller 208. Thereafter, the application roller 209 is caused to rotate pressed against a rotatable counter roller 201 which is rotating and the recording medium 203 passes between the application roller 209 and the rotatable counter roller 201. At this nip, the pre-processing fluid 205 is applied to the surface of the recording medium 203. At this point, a pressure controller 202 adjusts the nip pressure between the counter roller 201 and the application roller 209 to control the application amount of the pre-processing fluid 205. In addition, it is also possible to adjust the application amount of the pre-processing fluid 205 by controlling the rotation speed of the counter roller 201 and the application roller 209. The application roller 209 and the counter roller 201 are driven by a power supply such as drive motor. The rotation speed of the application roller 209 and the counter roller 201 can be controlled by adjusting the energy of the power supply.

By using the application roller 209 to apply the pre-processing fluid 205 to the recording area of the recording medium 203, the pre-processing fluid 205 having a relatively high viscosity can be thinly applied to the recording medium 203 to further reduce occurrence of uneven coloring.

The application method in the pre-processing unit 302 is not limited to the roll coating method. Other specific methods are, for example, blade coating method, gravure coating method, gravure offset coating method, bar code method, and roll coating method.

The pre-processing fluid 205 can be applied to the entire recording area of the recording medium 203 or only the area to which an image is formed.

The recording medium 203 to which the pre-processing fluid 205 is already applied is dried by heat rollers 311 and 312 of the drying unit 303. This unit conveys the recording medium 203 to which the pre-processing fluid 205 is applied to the heat rollers 311 and 312 by the conveyance rollers. The heat rollers 311 and 312 are heated to high temperatures from 50 to 100 degrees C. The moisture of the recording medium 203 to which the pre-processing fluid 205 is already applied evaporates by contact heat transfer from the heat rollers 311 and 312 so that the recording medium 203 becomes dry.

The drying unit in the first drying unit 303 is not limited to a heat roller. Other examples are an infra red drier, a microwave drier, a heat wind drier. These can be used alone or in combination.

Optionally, it is also possible to heat the recording medium 203 before the pre-processing fluid 205 is applied.

On the thus-dried recording medium 203, an image is formed by the inkjet recording unit 304 in accordance with image data.

The inkjet recording unit 304 is a full-line type head including four inkjet heads 304K, 304C, 304M, and 304Y of black K, cyan C, magenta M, and yellow Y, respectively, arranged in this order from upstream of the conveyance direction of the recording medium 203.

A single or multiple nozzle arrays are allowable.

The other heads 304C, 304M, and 304Y have the same configurations and the four inkjet heads 304K, 304C, 304M, and 304Y are arranged along the conveyance direction spaced the same distance therebetween. For this reason, an image can be formed on the whole width of the entire recording area by a single recording operation.

Optionally, a post-processing fluid is applied by the post-processing unit 305 to the recording medium 203 on which an image is formed.

The post-processing fluid forms a transparent protection layer on the recording medium 203 on which the image is formed.

The post-processing fluid can be applied to the entire recording area of the recording medium 203 or only the area to which the image is formed.

The recording medium 203 on which an image is formed or the recording medium 203 to which the post-processing fluid is applied is dried by heat rollers 313 and 314 of the second drying unit 306 in the same manner as in the first drying unit 303.

The dried recording medium 203 is reeled up by the reeling unit 308.

It is optional to provide a prior-to-reeling drying unit to dry the recording medium 203 before the recording medium 203 is reeled up by the reeling unit 308.

How to use the ink is not limited to the inkjet recording method.

Specific examples of such methods other than the inkjet recording method include, but are not limited to, blade coating methods, gravure coating methods, bar coating methods, roll coating methods, dip coating methods, curtain coating methods, slide coating methods, die coating methods, and spray coating methods.

The usage of the ink of the present disclosure is not particularly limited and can be suitably selected to suit to a particular application. For example, the ink can be used for printed matter, a paint, a coating material, and foundation. The ink can be used to form two-dimensional texts and images and furthermore a three-dimensional solid object (solid fabrication object or solid freeform fabrication object) as a material for 3D modeling.

Any known device can be used as the solid freeform fabrication device to fabricate a solid fabrication object with no particular limit. For example, the device is formed of a container, a supplying device, and a discharging device, a drier, etc. of ink. The solid fabrication object includes an object manufactured by repeated ink coating. In addition, the solid fabrication object includes a mold-processed product manufactured by processing a structure having a substrate such as a recording medium to which the ink is applied. The molded processed product is manufactured from recorded matter or a structure having a sheet-like form, film-like form, etc. by, for example, heating drawing or punching. The molded processed product is suitably used for articles which are molded after surface-decorating. Examples are gauges or operation panels of vehicles, office machines, electric and electronic devices, cameras, etc.

It is also possible to form an image on a recording medium to produce printed matter using the image forming method described above, which can be a method of producing the printed matter.

Image forming, recording, printing, print, etc. in the present disclosure represent the same meaning.

Also, recording media, media, substrates in the present disclosure have the same meaning.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but is not limited thereto.

### Preparation Example 1 of Pigment Dispersion

Preparation of Magenta Pigment Dispersion A

After preliminarily mixing the following recipe, the mixture was subject to circulation dispersion for seven hours with a disk type bead mill (KDL type, media: zirconia ball having a diameter of 0.3 mm, manufactured by SHINMARU ENTERPRISES CORPORATION) to obtain a magenta pigment dispersion A (pigment concentration: 15 percent by mass).

### Recipe

| | | |
|---|---|---|
| C.I. Pigment Red 269 (manufactured by Clariant) | 15 | parts by mass |
| Acrylic-based polymeric dispersant | 5 | parts by mass |
| (DISPERBYK-2010, available from BYK Japan | | |
| KK) | | |
| Deionized water: | 80 | parts by mass |

### Preparation Example 2 of Pigment Dispersion

Preparation of Magenta Pigment Dispersion B

After preliminarily mixing the following recipe, the mixture was subject to circulation dispersion for seven hours with a disk type bead mill (KDL type, media: zirconia ball having a diameter of 0.3 mm, manufactured by SHINMARU ENTERPRISES CORPORATION) to obtain a magenta pigment dispersion B (pigment concentration: 15 percent by mass).

Recipe

| | | |
|---|---|---|
| C.I. Pigment Red 122 (manufactured by Clariant) | 15 | parts by mass |
| Acrylic-based polymeric dispersant | 5 | parts by mass |
| (DTSPERBYK-2010, manufactured by BYK Japan | | |
| KK) | | |
| Deionized water: | 80 | parts by mass |

### Preparation Example 1 of Pre-Processing Fluid

Preparation of Pre-Processing Fluid 1

A pre-processing fluid 1 was obtained by mixing and stirring the following recipe followed by filtration through a filter having an average pore diameter of 5 micrometers (MINISART, manufactured by Sartorius Stedim Biotech GmbH).

Recipe

| | | |
|---|---|---|
| Calcium acetate monohydrate: | 2 | parts by mass |
| WET-270 (silicone-based surfactant, manufactured | 1 | part by mass |
| by Evonik): | | |
| PROXEL LV (preservative, manufactured by | 0.1 | parts by mass |
| Avecia Inkjet Limited): | | |
| 1,2-Propanediol: | 5 | parts by mass |
| 3-Methoxybutanol: | 25 | parts by mass |

| | |
|---|---|
| Deionized water: balance | (100 parts by |
| | mass in total) |

### Preparation Examples 2 to 11 of Pre-Processing Fluid

Preparation Method of Pre-Processing Fluids 2 to 11

The pre-processing fluids 2 to 11 were prepared in the same manner as in Preparation Example 1 of Pre-processing Fluid except that the recipes were changed as shown in the following Tables 1 and 2.

Mixing SP Value of Organic Solvents

The mixing SP value of a liquid mixture of organic solvents contained in the pre-processing fluid prepared as below was calculated according to the relationship 1 below. In addition, if only a single organic solvent is used, the SP value of the organic solvent is defined as the mixing SP value.

Mixing SP value (cal/cm³)^{0.5} of the liquid mixture of the organic solvents in the prepared pre-processing fluid=[SP value of organic solvent A×molar fraction of organic solvent A]+[SP value of organic solvent B×molar fraction of organic solvent B]+ Relationship 1

TABLE 1

| | | Pre-processing fluid No. | | | | |
|---|---|---|---|---|---|---|
| | | 1 | 2 | 3 | 4 | 5 |
| Multi-valent | Calcium acetate monohydrate | 2 | | | | |
| metal salt | Calcium nitrate tetrahydrate | | 2 | | | |
| | Calcium chloride hexahydrate | | | 2 | | |
| | Magnesium acetate tetrahydrate | | | | 2 | |
| | Magnesium sulfate (anhydrous) | | | | | 2 |
| Surfactant | WET-270 | 1 | | | | |
| | BYK-348 | | 1 | | | |
| | SURFYNOL 440 | | | 1 | | |
| | SURFYNOL 465 | | | | 1 | |
| | SURFYNOL 485 | | | | | 1 |
| | EMASOL L-10V | | | | | |
| | RHEODOL AO-15V | | | | | |
| | FS-300 | | | | | |
| Organic | 1,2,-Propanediol | 5 | | | | 15 |
| solvent | (SP value: 13.5 [cal/cm³]^{1/2}) | | | | | |
| | Glycerin | | 5 | | | |
| | (SP value: 16.4 [cal/cm³]^{1/2}) | | | | | |
| | 1,3-Butanediol | | | 5 | | |
| | (SP value: 12.8 [cal/cm³]^{1/2}) | | | | | |
| | 1,3-Propanediol | | | | 5 | |
| | (SP value: 13.7 [cal/cm³]^{1/2}) | | | | | |
| | 2-Ethoxyethanol | | | | | |
| | (SP value: 10.4 [cal/cm³]^{1/2}) | | | | | |
| | 3-Methoxy-3-methyl-1-butanol | | | | | 20 |
| | (SP value: 9.6 [cal/cm³]^{1/2}) | | | | | |
| | Propylene glycol n propyl ether | | | | | |
| | (SP value: 9.8 [cal/cm³]^{1/2}) | | | | | |
| | 3-Methoxybutanol | 25 | 25 | 25 | 25 | |
| | (SP value: 10.9 [cal/cm³]^{1/2}) | | | | | |
| Preservative | PROXEL LV | 0.1 | 0.1 | 0.1 | 0.1 | 0.1 |
| Water | Ion-exchanged water | balance | balance | balance | balance | balance |

| | | | | | |
|---|---|---|---|---|---|
| Total (part by mass) | 100 | 100 | 100 | 100 | 100 |
| Mixing SP value ([cal/cm³]^{1/2}) of organic solvents | 11.5 | 11.9 | 11.3 | 11.5 | 11.7 |

TABLE 2

| | | Pre-processing | | | | | |
|---|---|---|---|---|---|---|---|
| | | fluid No. | | | | | |
| | | 6 | 7 | 8 | 9 | 10 | 11 |
| Multi-valent | Calcium acetate | 2 | | | | 2 | 2 |
| metal salt | monohydrate | | | | | | |
| | Calcium nitrate | | 2 | | | | |
| | tetrahydrate | | | | | | |
| | Calcium chloride | | | 2 | | | |
| | hexahydrate | | | | | | |
| | Magnesium acetate | | | | | | |
| | tetrahydrate | | | | | | |
| | Magnesium sulfate | | | | | | |
| | (anhydrous) | | | | | | |
| Surfactant | WET-270 | | | | | 1 | 1 |
| | BYK-348 | | | | | | |
| | SURFYNOL 440 | | | | 1 | | |
| | SURFYNOL 465 | | | | | | |
| | SURFYNOL 485 | | | | | | |
| | EMASOL L-10V | 1 | | | | | |
| | RHEODOL AO-15V | | 1 | | | | |
| | FS-300 | | | 1 | | | |
| Organic | 1,2,-Propanediol | 5 | 10 | 10 | 5 | 15 | |
| solvent | (SP value: 13.5 [cal/cm³]^{1/2}) | | | | | | |
| | Glycerin | | | | | | |
| | (SP value: 16.4 [cal/cm³]^{1/2}) | | | | | | |
| | 1,3-Butanediol | | | | | | |
| | (SP value: 12.8 [cal/cm³]^{1/2}) | | | | | | |
| | 1,3-Propanediol | | | | | | |
| | (SP value: 13.7 [cal/cm³]^{1/2}) | | | | | | |
| | 2-Ethoxyethanol | | | 20 | | | 3 |
| | (SP value: 10.4 [cal/cm³]^{1/2}) | | | | | | |
| | 3-Methoxy-3-methyl-1-butanol | 30 | | | | | |
| | (SP value: 9.6 [cal/cm³]^{1/2}) | | | | | | |
| | Propylene glycol n propyl ether | | 20 | | | 10 | 20 |
| | (SP value: 9.8 [cal/cm³]^{1/2}) | | | | | | |
| | 3-Methoxybutanol | | | | 25 | | |
| | (SP value: 10.9 [cal/cm³]^{1/2}) | | | | | | |
| Preservative | PROXEL LV | 0.1 | 0.1 | 0.1 | 0.1 | 0.1 | 0.1 |
| Water | Ion-exchanged water | balance | balance | balance | balance | balance | balance |

| | | | | | | |
|---|---|---|---|---|---|---|
| Total (part by mass) | 100 | 100 | 100 | 100 | 100 | 100 |
| Mixing SP value ([cal/cm³]^{1/2}) of organic solvents | 10.4 | 11.4 | 11.6 | 11.5 | 12.4 | 9.9 |

The details of the individual ingredients in Tables 1 and 2 are as follows:
BYK-348, (silicone-based surfactant, manufactured by BYK-Chemie GmbH)
SURFYNOL 440: acetylene glycol-based surfactant, manufactured by Air Products and Chemicals, Inc.
SURFYNOL 465: acetylene glycol-based surfactant, manufactured by Air Products and Chemicals, Inc.
SURFYNOL 485: acetylene glycol-based surfactant, manufactured by Air Products and Chemicals, Inc.
EMASOL L-10V: sorbitan monolaurate, manufactured by Kao Corporation
FS-300: Fluorochemical surfactant, manufactured by E.I. du Pont de Nemours and Company

### Manufacturing Example 1 of Ink

Manufacturing of Magenta Ink 1

The following ink recipe was mixed and stirred followed by filtration by a polypropylene filter having an average pore diameter of 0.8 μm to obtain Magenta ink 1.

Ink Recipe

| | | |
|---|---|---|
| Magenta pigment dispersion: | 20 | parts |
| WET-270 (silicone-based surfactant, manufactured | 1 | part by mass |
| by Evonik): | | |
| PROXEL LV (preservative, manufactured by | 0.1 | parts by mass |
| Avecia Inkjet Limited): | | |
| 1,2-Propanediol: | 25 | parts by mass |
| Propylene glycol monomethyl ether acetate: | 5 | parts by mass |

Deionized water: balance (100 parts by mass in total)

### Manufacturing Examples 2 to 14 of Ink

Manufacturing of Magenta Inks 2 to 14

The magenta inks 2 to 14 were prepared in the same manner as in Manufacturing Example 1 of Ink except that the recipes were changed as shown in the following Tables 3 and 4.

TABLE 3

| | | Ink No. | | | | | | |
|---|---|---|---|---|---|---|---|---|
| | | 1 | 2 | 3 | 4 | 5 | 6 | 7 |
| Colorant | Magenta pigment dispersion A | 20 | 20 | 20 | 20 | 20 | 20 | 20 |
| | Magenta pigment dispersion B | | | | | | | |
| Surfactant | WET-270 | 1 | | | | | | |
| | BYK-348 | | 1 | | | | | |
| | SURFYNOL 440 | | | 1 | | | | |
| | SURFYNOL 465 | | | | 1 | | | |
| | SURFYNOL 485 | | | | | 1 | | |
| | EMASOL L-10V | | | | | | 1 | |
| | RHEODOL AO-15V | | | | | | | 1 |
| | FS-300 | | | | | | | |
| Organic | 1,2,-Propanediol | 25 | 30 | | 20 | | 20 | 20 |
| solvent | (SP value: 13.5 [cal/cm³]^{1/2}) | | | | | | | |
| | Glycerin | | 5 | | | | | |
| | (SP value: 16.4 [cal/cm³]^{1/2}) | | | | | | | |
| | 1,3-Butanediol | | | 20 | | 15 | | |
| | (SP value: 12.8 [cal/cm³]^{1/2}) | | | | | | | |
| | 1,3-Propanediol | | | | 10 | 15 | | |
| | (SP value: 13.7 [cal/cm³]^{1/2}) | | | | | | | |
| | 2-Ethoxyethanol | | | | | | | |
| | (SP value: 10.4 [cal/cm³]^{1/2}) | | | | | | | |
| | 3-Methoxy-3-methyl-1-butanol | | | | | | | |
| | (SP value: 9.6 [cal/cm³]^{1/2}) | | | | | | | |
| | Ethylene glycol monomethyl ether acetate | | | | | | | 5 |
| | (SP value: 9.0 [cal/cm³]^{1/2}) | | | | | | | |
| | Propylene glycol monomethyl ether acetate | 5 | | 5 | | | | |
| | (SP value: 8.7 [cal/cm³]^{1/2}) | | | | | | | |
| | Propylene glycol n propyl ether | | | | | | | |
| | (SP value: 9.8 [cal/cm³]^{1/2}) | | | | | | | |
| | 3-Methoxybutanol | | | | | | 10 | |
| | (SP value: 10.9 [cal/cm³]^{1/2}) | | | | | | | |
| Preservative | PROXEL LV | 0.1 | 0.1 | 0.1 | 0.1 | 0.1 | 0.1 | 0.1 |
| Water | Ion-exchanged water | balance | balance | balance | balance | balance | balance | balance |

| | | | | | | | |
|---|---|---|---|---|---|---|---|
| Total (part by mass) | 100 | 100 | 100 | 100 | 100 | 100 | 100 |
| Mixing SP value ([cal/cm³]^{1/2}) of organic solvents | 13.0 | 13.9 | 12.2 | 13.6 | 13.3 | 12.8 | 12.9 |

TABLE 4

| | | Ink No. | | | | | | |
|---|---|---|---|---|---|---|---|---|
| | | 8 | 9 | 10 | 11 | 12 | 13 | 14 |
| Colorant | Magenta pigment dispersion A | 20 | 20 | 20 | 20 | | 20 | 20 |
| | Magenta pigment dispersion B | | | | | 20 | | |
| Surfactant | WET-270 | | 1 | | | | | 1 |
| | BYK-348 | | | 1 | | | | |
| | SURFYNOL 440 | | | | 1 | | | |
| | SURFYNOL 465 | | | | | 1 | | |
| | SURFYNOL 485 | | | | | | | |
| | EMASOL L-10V | | | | | | | |
| | RHEODOL AO-15V | | | | | | | |
| | FS-300 | 1 | | | | | | |
| Organic | 1,2,-Propanediol | 30 | | 20 | 25 | 30 | 20 | 10 |
| solvent | (SP value: 13.5 [cal/cm³]^{1/2}) | | | | | | | |
| | Glycerin | | 15 | | | | 8 | |
| | (SP value: 16.4 [cal/cm³]^{1/2}) | | | | | | | |
| | 1,3-Butanediol | | | | | | | |
| | (SP value: 12.8 [cal cm³]^{1/2}) | | | | | | | |
| | 1,3-Propanediol | | | | | | | |
| | (SP value: 13. 7 [cal/cm³]^{1/2}) | | | | | | | |
| | 2-Ethoxyethanol | | 10 | | | | | |
| | (SP value: 10.4 [cal/cm³]^{1/2}) | | | | | | | |
| | 3-Methoxy-3-methyl-1-butanol | 5 | | 15 | | 5 | | |
| | (SP value: 9.6 [cal/cm³]^{1/2}) | | | | | | | |
| | Ethylene glycol monomethyl ether acetate | | | | | | | 10 |
| | (SP value: 9.0 [cal/cm³]^{1/2}) | | | | | | | |
| | Propylene glycol monomethyl ether acetate | | | | | | | |
| | (SP value: 8.7 [cal/cm³]^{1/2}) | | | | | | | |
| | Propylene glycol n propyl ether | | | | 5 | | | |
| | (SP value: 9.8 [cal/cm³]^{1/2}) | | | | | | | |
| | 3-Methoxybutanol | | | | | | | |
| | (SP value: 10.9 [cal/cm³]^{1/2}) | | | | | | | |
| Preservative | PROXEL LV | 0.1 | 0.1 | 0.1 | 0.1 | 0.1 | 0.1 | 0.1 |
| Water | Ion-exchanged water | balance | balance | balance | balance | balance | balance | balance |

| | | | | | | | |
|---|---|---|---|---|---|---|---|
| Total (part by mass) | 100 | 100 | 100 | 100 | 100 | 100 | 100 |
| Mixing SP value ([cal/cm³]^{1/2}) of organic solvents | 13.1 | 14.0 | 12.2 | 13.1 | 13.1 | 14.2 | 11.7 |

The details of the individual ingredients in tables 3 and 4 are as follows:
RHEODOL AO-15V: sorbitan sesquioleate, manufactured by Kao Corporation

### Examples 1 to 14 and Comparative Examples 1 to 6

Next, using image forming sets obtained by combining the pre-processing fluids and the inks as shown in Table 5 to Table 7, properties were evaluated in the manners described below. The results are shown in Tables 5 to 7.

Evaluation on Ink Wettability

Using an inkjet printer (IPSIO GXE5500, manufactured by Ricoh Company, Ltd.) loaded with each ink, a single dot image of 4 pL was printed over each of films of PP, PET, and ONY, which were coated with each pre-processing fluid using a bar coater and dried for two minutes using a drier at 80 degrees C. The dot diameter was measured using a digital microscope (DIGITAL MICROSCOPE VHX-200, manufactured by Keyence Corporation).

This evaluation was graded based on the difference between the maximum value and the minimum value of the dot diameters on the three types of non-absorptive recording media, to evaluate ink wettability. It was determined as practically usable when graded B or above.

### Evaluation Criteria

A: The difference between the maximum dot diameter and the minimum dot diameter of the non-absorptive recording media was from 0 to less than 3 micrometers.

B: The difference between the maximum dot diameter and the minimum dot diameter of the non-absorptive recording media was from 3 to less than 5 micrometers.

C: The difference between the maximum dot diameter and the minimum dot diameter of the non-absorptive recording media was from 5 to less than 10 micrometers.

D: The difference between the maximum dot diameter and the minimum dot diameter of the non-absorptive recording media was from 10 to 20 micrometers.

Product names and supplier names of the three types of non-absorptive recording media used in the evaluation of ink wettability are as follows.

Non-Absorptive Recording Medium
PP: PYLEN® P2102, manufactured by TOYOBO CO., LTD.
PET: ESPET® E5100, manufactured by TOYOBO CO., LTD.
ONY: HARDEN N1100, manufactured by Toyobo Co., Ltd.,

Bleeding

Using an inkjet printer (IPSIO GXE5500, manufactured by Ricoh Company, Ltd.) loaded with each ink, a solid image was formed at 1,200 dpi over a polyethylene terephthalate (PET) film, which was coated with each pre-processing fluid using a bar coater and dried for two minutes using a drier at 80 degrees C. The exudation distance of the image portion exuded to the non-printed portion of the recording medium was measured by visual observation on the end of the formed solid image to evaluate the degree of bleeding according to the following criteria. It was determined as practically usable when graded B or above.

Evaluation Criteria

A: No bleeding present
B: Bleeding less than 1 mm present
C: Bleeding from 1 mm to less than 3 mm present
D: Bleeding not less than 3 mm present

Color Developability

10 sheets of Recopy PPC Paper Type 6200 (manufactured by Ricoh Co., Ltd.) was placed under a recording medium as a lining for color measurement. Using a spectrophotometric densitometer (X-Rite 939, manufactured by X-Rite Inc.), optical density (magenta) was measured at any five positions in the printed image to obtain the average value thereof to evaluate color developability according to the following criteria. It was determined as practically usable when graded B or above.

Evaluation Criteria

A: Optical density (magenta) was 2.0 or greater
B: Optical density (magenta) was from 1.5 to less than 2.0
B: Optical density (magenta) was from 1.2 to less than 1.5
A: Optical density (magenta) was less than 1.2

Drying Property

Using an inkjet printer (IPSIO GXE5500, manufactured by Ricoh Company, Ltd.) loaded with each manufactured ink, a solid image was printed at 1200 dpi×1200 dpi over a polyethylene terephthalate (PET) film, which was coated with each pre-processing fluid using a bar coater and dried for two minutes using a drier at 80 degrees C. Subsequently, the solid image was dried using a drier at 80 degrees C. for a drying time of 30 seconds. Subsequently, the PET film was taken out and the solid image portion was rubbed with a finger, to evaluate the condition of the rubbed image according to the following criteria. Notably, the liquid composition having a tacking force of 50 mN or less is practically usable.

Evaluation Criteria

A: The image was not scraped at all.
B: Less than 5% of the rubbed portion peeled.
C: Five to ten percent of the rubbed portion peeled.
D: Ten percent or greater of the rubbed portion peeled.

Discharging Stability of Ink

An inkjet printer (remodeled IPSIO GXE5500, manufactured by Ricoh Company, Ltd.) was loaded with each ink, to evaluate discharging stability after decapping. First, in an environment of 25 degrees C. and 20 percent RH, the head was cleaned in response to the maintenance command of an inkjet printer, a test chart was printed, and all the channels of the nozzles were confirmed to be in a discharging state. Next, the head was left to stand for ten minutes decapped. Subsequently, the test chart was printed again. The number of non-discharging channels was counted from the test chart before and after being left to stand, to evaluate discharging stability of the ink according to the following criteria. It was determined as practically usable when graded B or above.

Evaluation Criteria

A: Number of non-discharging channels was 1 or less
B: Number of non-discharging channels was from 2 to less than 10
C: Number of non-discharging channels was from 10 to less than 20
D: Number of non-discharging channels was 20 or more

TABLE 5

| | Ex. 1 | Ex. 2 | Ex. 3 | Ex. 4 | Ex. 5 | Ex. 6 | Ex. 7 |
|---|---|---|---|---|---|---|---|
| Pre-processing | Pre-processing | Pre-processing | Pre-processing | Pre-processing | Pre-processing | Pre-processing | Pre-processing |
| fluid No. | fluid 1 | fluid 2 | fluid 3 | fluid 4 | fluid 1 | fluid 2 | fluid 3 |
| Ink No. | Ink 1 | Ink 4 | Ink 5 | Ink 2 | Ink 3 | Ink 6 | Ink 8 |
| Ink | B | B | B | B | B | A | A |
| wettability | | | | | | | |
| Bleed | B | B | B | B | B | B | B |
| Color | B | B | B | B | B | B | A |
| developability | | | | | | | |
| Drying | B | B | B | B | B | B | B |
| property | | | | | | | |
| Ink discharging | B | B | B | B | B | B | B |
| stability | | | | | | | |

TABLE 6

| | Ex. 8 | Ex. 9 | Ex. 10 | Ex. 11 | Ex. 12 | Ex. 13 | Ex. 14 |
|---|---|---|---|---|---|---|---|
| Pre-processing | Pre-processing | Pre-processing | Pre-processing | Pre-processing | Pre-processing | Pre-processing | Pre-processing |
| fluid No. | fluid 4 | fluid 1 | fluid 2 | fluid 5 | fluid 6 | fluid 7 | fluid 8 |
| Ink No. | Ink 9 | Ink 10 | Ink 7 | Ink 11 | Ink 11 | Ink 8 | Ink 8 |
| Ink | A | A | B | A | A | A | A |
| wettability | | | | | | | |
| Bleed | B | B | B | A | A | A | A |
| Color | A | A | A | A | A | A | A |
| developability | | | | | | | |
| Drying | B | B | B | A | A | A | A |
| property | | | | | | | |
| Ink discharging | B | B | B | B | B | B | B |
| stability | | | | | | | |

TABLE 7

| | Comp. Ex. 1 | Comp. Ex. 2 | Comp. Ex. 3 | Comp. Ex. 4 | Comp. Ex. 5 | Comp. Ex. 6 |
|---|---|---|---|---|---|---|
| Pre-processing | Pre-processing | Pre-processing | Pre-processing | Pre-processing | Pre-processing | Pre-processing |
| fluid No. | fluid 9 | fluid 10 | fluid 8 | fluid 8 | fluid 11 | fluid 8 |
| Ink No. | Ink 8 | Ink 8 | Ink 12 | Ink 13 | Ink 8 | Ink 14 |
| Ink wettability | D | C | B | C | C | C |
| Bleed | D | C | B | B | C | B |
| Color | C | B | D | B | B | B |
| developability | | | | | | |
| Drying property | B | B | B | C | B | C |
| Ink discharging | B | B | C | C | B | C |
| stability | | | | | | |

Aspects of the present disclosure are, for example, as follows.

1. An image forming method includes applying a pre-processing fluid to a non-absorptive recording medium, the pre-processing fluid containing a multi-valent metal salt and at least one organic solvent and applying a magenta ink containing C.I. Pigment Red 269 and at least one organic solvent, wherein the mixing SP value of the at least one organic solvent contained in the pre-processing fluid is from 10.0 to 12.0 (cal/cm³), wherein the mixing SP value of the at least one organic solvent contained in the magenta ink is from 12.0 to 14.0 (cal/cm³).

2. The image forming method according to 1 mentioned above, wherein the magenta ink is applied by an inkjet method.

3. The image forming method according to 1 or 2 mentioned above, wherein the at least one organic solvent in the magenta ink contains a glycol ether compound.

4. The image forming method according to any one of 1 to 3 mentioned above, wherein the magenta ink contains an organic solvent having an SP value of from 9.0 to 10.5 (cal/cm³).

5. The image forming method according to any one of 1 to 4 mentioned above, wherein the pre-processing fluid contains an organic solvent having an SP value of from 9.0 to 10.5 (cal/cm³).

6. The image forming method according to any one of 1 to 5 mentioned above, wherein the multi-valent metal salt is at least one of a calcium salt and a magnesium salt.

7. An image forming apparatus includes a pre-processing fluid applying device configured to apply a pre-processing fluid to a non-absorptive recording medium, the pre-processing fluid containing a multi-valent metal salt and at least one organic solvent and an ink applying device configured to apply a magenta ink containing C.I. Pigment Red 269 and at least one organic solvent, wherein the mixed SP value of the at least one organic solvent contained in the pre-processing fluid is from 10.0 to 12.0 (cal/cm³), wherein the mixed SP value of the at least one organic solvent contained in the magenta ink is from 12.0 to 14.0 (cal/cm³).

8. The device according to 7 mentioned above, wherein the ink applying device is an inkjet discharging head.

9. The image forming method according to 7 or 8 mentioned above, wherein the at least one organic solvent in the magenta ink contains a glycol ether compound.

10. The image forming method according to any one of 7 to 9 mentioned above, wherein the magenta ink contains an organic solvent having an SP value of from 9.0 to 10.5 (cal/cm³).

11. The image forming method according to any one of 7 to 10 mentioned above, wherein the pre-processing fluid contains an organic solvent having an SP value of from 9.0 to 10.5 (cal/cm³).

12. The image forming apparatus according to any one of 7 to 11 mentioned above, wherein the multivalent metal salt is at least one of a calcium salt and a magnesium salt.

13. An image forming set contains a pre-processing fluid containing a multi-valent metal salt and at least one organic solvent, a magenta ink containing C.I. Pigment Red 269 and at least one organic solvent, wherein the mixing SP value of the at least one organic solvent contained in the pre-processing fluid is from 10.0 to 12.0 (cal/cm³), the mixing SP value of the at least one organic solvent contained in the magenta ink is from 12.0 to 14.0 (cal/cm³).

14. A method of manufacturing printed matter, utilizing the image forming method of any one of 1 to 6 mentioned above.

15. Image formed matter formed by the image forming apparatus according to any one of 7 to 12 mentioned above.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. An image forming method comprising:
applying a pre-processing fluid to a non-absorptive recording medium, the pre-processing fluid containing a multi-valent metal salt and at least one organic solvent; and
applying a magenta ink containing C.I. Pigment Red 269 and at least one organic solvent,
wherein a mixing SP value of the at least one organic solvent contained in the pre-processing fluid is from 10.0 to 12.0 (cal/cm³),
wherein a mixing SP value of the at least one organic solvent contained in the magenta ink is from 12.0 to 14.0 (cal/cm³).

2. The image forming method according to claim 1, wherein the applying the magenta ink is conducted in an inkjet method.

3. The image forming method according to claim 1, wherein the at least one organic solvent contained in the magenta ink contains a glycol ether compound.

4. The image forming method according to claim 1, wherein the magenta ink contains an organic solvent having an SP value of from 9.0 to 10.5 (cal/cm³).

5. The image forming method according to claim 1, wherein the pre-processing fluid contains an organic solvent having an SP value of from 9.0 to 10.5 (cal/cm³).

6. The image forming method according to claim 1, wherein the multi-valent metal salt comprises at least one of a calcium salt and a magnesium salt.

7. An image forming apparatus comprising:
a pre-processing fluid applying device configured to apply a pre-processing fluid to a non-absorptive recording medium, the pre-processing fluid containing a multi-valent metal salt and at least one organic solvent; and
an ink applying device configured to apply a magenta ink containing C.I. Pigment Red 269 and at least one organic solvent,
wherein a mixing SP value of the at least one organic solvent contained in the pre-processing fluid is from 10.0 to 12.0 (cal/cm³),
wherein a mixing SP value of the at least one organic solvent contained in the magenta ink is from 12.0 to 14.0 (cal/cm³).

8. An image forming set comprising:
a pre-processing fluid containing a multi-valent metal salt and at least one organic solvent;
a magenta ink containing C.I. Pigment Red 269 and at least one organic solvent,
wherein a mixing SP value of the at least one organic solvent contained in the pre-processing fluid is from 10.0 to 12.0 (cal/cm³),
a mixing SP value of the at least one organic solvent contained in the magenta ink is from 12.0 to 14.0 (cal/cm³).

9. A method of producing printed matter comprising:
producing the printed matter utilizing the image forming method of claim 1.
